(19) United States
(12) Patent Application Publication
(10) Pub. No.: US 2018/0136431 A1
(43) Pub. Date: May 17, 2018

(54) Single-shaft lens device for unmanned aerial vehicles

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/853,719

(22) Filed: Dec. 23, 2017

(30) Foreign Application Priority Data
Dec. 27, 2016 (CN) 201621449439.3
Dec. 27, 2016 (CN) 201621449452.9

(51) Int. Cl. G02B 7/02; H04N 5/225; B64D 47/08

(52) U.S. Cl. CPC G02B 7/023; G02B 7/021; B64C 39/024; B64D 47/08; H04N 5/2254

(57) ABSTRACT

A single-shaft lens device for a UAV (unmanned aerial vehicle), which includes a drive apparatus and a lens apparatus, wherein: the lens apparatus is driven through the drive apparatus to uniaxially rotate around a lens shaft; the lens apparatus includes a lens front cover, a lens rear cover, a lens module and a first circuit board; the lens shaft is sleeved to the lens front cover or the lens rear cover; the lens module is buckled with the lens front cover, the first circuit board tightly presses the lens module and is connected with the lens front cover, the lens rear cover is connected with the lens front cover after the lens rear cover is covered with the lens front cover.

### CROSS REFERENCE OF RELATED APPLICATION

The present invention claims priority under 35 U.S.C. 119(a-d) to CN 201621449452.9, filed Dec. 27, 2016 and CN 201621449439.3, filed Dec. 27, 2016.

### BACKGROUND OF THE PRESENT INVENTION

### Field of Invention

The present invention relates to a technical field of UAV (unmanned aerial vehicle), and more particularly to a single-shaft lens device for a UAV.

### Description of Related Arts

Unmanned aerial vehicles are abbreviated as “UAVs”, which is operated with the radio remote control equipment and own program control device. UAVs are generally equipped with a lens device for image capture, the captured images are transmitted to the main control circuit of the UAV for processing. Existing lens devices include multi-shaft lens devices and single-shaft lens devices. Among them, due to the need for rotation in multiple directions, the multi-shaft lens devices require a larger working space, so that the volume of the UAV will be too large, which is not conducive to miniaturization. The single-shaft lens devices only rotate in one direction, and the full-angle shooting is achieved through the action of the UAV. At present, the lens of the single-shaft lens device needs more screws to be fixed, so that the weight is heavy, and a certain amount of interferences occur.

In addition, the UAV also generally includes a GPS positioning module and a visual positioning module. The visual positioning module may use an optical flow lens to capture an environmental image and determine whether a displacement occurs by distinguishing the gray level change or the brightness change of a pixel in the image, so as to achieve positioning.

In existing UAVs, the optical flow lens is usually mounted directly on the PCB (printed circuit board). Generally speaking, there is a certain distance between the PCB and the bottom of the aircraft housing, so that the optical flow lens is also away from the bottom of the aircraft housing. Therefore, the accuracy of visual positioning is not high. Moreover, the manner that the optical flow lens is mounted to the PCB is not easy to assemble.

### SUMMARY OF THE PRESENT INVENTION

A technical problem to be solved of the present invention is to provide a single-shaft lens device for a UAV (unmanned aerial vehicle), which is simple in assembly and light in weight, and is able to reduce interferences.

To solve the above problem, the present invention provides a single-shaft lens device for a UAV, which comprises a driving apparatus and a lens apparatus, wherein:

the lens apparatus is driven through the drive apparatus to uniaxially rotate around a lens shaft; the lens apparatus comprises a lens front cover, a lens rear cover, a lens module and a first circuit board; the lens shaft is sleeved to the lens front cover or the lens rear cover; the lens module is buckled with the lens front cover, the first circuit board tightly presses the lens module and is connected with the lens front cover, the lens rear cover is connected with the lens front cover after the lens rear cover is covered with the lens front cover.

Preferably, a drawtube tank is provided on the lens front cover, a front end of the lens module extends into the drawtube tank for positioning, a hook is located at a tank edge of the drawtube tank, a lug is located at a rear end of the lens module, the lug is buckled with the hook when the lens module extends in position, so that the lens module is fixed to the lens front cover.

Preferably, a top surface of each hook faces towards an inner side of the drawtube tank and is downwardly inclined.

Preferably, the first circuit board is connected with a first screw connection portion of the lens front cover through a first screw component in a screw connection manner, such that the lens module is tightly pressed and is fixedly connected with the lens front cover.

Preferably, at least two first positioning blocks are located at an inner side of the lens front cover, the first circuit board is positioned between the first positioning blocks.

Preferably, the lens rear cover is connected with a second screw connection portion of the lens front cover in a screw connection manner through a second screw component.

Preferably, the lens module is connected with the first circuit board through a first FPC (flexible printed circuit) line, the first circuit board is connected with an external circuit through a second FPC line, the second FPC line extends to an exterior through an opening of the lens rear cover.

Preferably, a transparent protective lens is located at the lens front cover corresponding to the lens module.

Preferably, the drive apparatus comprises an actuator and a gear, the gear comprises a drive wheel and a driven wheel, the drive wheel is connected with the actuator to rotate under a drive of the actuator, the driven wheel is connected with the lens apparatus and is engaged with the drive wheel, the drive wheel drives the driven wheel to rotate so as to drive the lens apparatus to rotate around the lens shaft to achieve a single-axle rotation.

Preferably, the single-shaft lens device for the UAV further comprises a lens support for installing the drive apparatus and the lens apparatus, two ends of the lens shaft are fixed to the lens support.

Also, the present invention provides an optical flow lens installation structure for a UAV (unmanned aerial vehicle), wherein:

the UAV comprises an aircraft housing and a second circuit board located inside the aircraft housing;

the optical flow lens installation structure comprises an optical flow support and an optical flow lens unit;

the optical flow support is arched and comprises an arched portion and two arms downwardly extended from two ends of the arched portion, respectively;

the arched portion of the optical flow support comprises an installation concave part for installing the optical flow lens unit;

two ends of the optical flow support embrace the second circuit board for fixing and allows the optical flow lens unit to face towards a bottom of the aircraft housing.

Preferably, the optical flow support further comprises flexible flips which are respectively located at the two ends thereof and are flipped up away from the arched portion, the flexible flips respectively are in matched connection with two sides of the second circuit board, the flexible flips embrace the second circuit board after being reset and closed.

Preferably, second positioning blocks are respectively located at two sides of the second circuit board for positioning the optical flow support.

Preferably, one side of the installation concave part of the optical flow support is opened for allowing the optical flow lens unit to slide into the installation concave part.

Preferably, two flexible fixing blocks are located on the optical flow support and are respectively fixed at two sides of the installation concave part; when the optical flow lens unit slides, the flexible fixing blocks flexibly act along a sliding direction of the optical flow lens unit; after the optical flow lens unit slides into the installation concave part in position, the two flexible fixing blocks are flexibly reset to embrace the optical flow lens unit.

Preferably, each of the flexible fixing blocks is concaved, a concave direction of a concave portion of every flexible fixing block is opposite to the sliding direction of the optical flow lens unit, a transition cutting angle is provided at a position where every flexible fixing block is pushed by the sliding optical flow lens unit, a position where every flexible fixing block embraces the optical flow lens unit is an arc which matches with the optical flow lens unit.

Preferably, the optical flow support has at least one reducing hole.

Preferably, a buffer foam is located between an installation position of the optical flow lens and the second circuit board for buffering the optical flow lens.

Preferably, the buffer foam is adapted for fixing connection wires, which are configured to connect the optical flow lens unit with the second circuit board, on the second circuit board.

Preferably, an optical flow lens, adapted for light transmission and protection, is located at a position where is corresponding to the optical flow lens unit at the bottom of the aircraft housing.

Through the above technical solutions, compared with the prior art, the present invention has beneficial effects as follows.

To better collect images, a lens shooting portion generally extends a distance relatively to other portions of the lens apparatus, and the lens apparatus rotates around the single shaft, which is able to save a larger exercise space and reduce a volume and weight of the aircraft housing of the UAV. The lens module is buckled with the lens front cover for eliminating the installation of screws, which is simple in assembling and disassembling manners and is able to reduce a whole weight and decrease the signal interference. Moreover, through tightly pressing the lens module to the lens front cover via the first circuit board, so as to further fix the lens module for obtaining a more stable installation manner.

Through the drawtube tank, the lens module is rapidly positioned, and the lens shooting portion extends outside a distance relatively to other portions of the lens apparatus; the buckling between the hooks and the lugs is able to complete the buckling during the process of downwardly pressing the lens module in the drawtube tank, so that the buckling manner is more stable and convenient.

### BRIEF DESCRIPTION OF THE DRAWINGS

FIG. 1 is an exploded view of a single-shaft lens device for a UAV (unmanned aerial vehicle) according to a first embodiment of the present invention.

FIG. 2 is a structurally schematic view of assembling a lens front cover with a lens module according to the first embodiment of the present invention.

FIG. 3 is a structurally schematic view of assembling a lens front cover with a circuit board according to the first embodiment of the present invention.

FIG. 4 is a sectional structure diagram of assembling the lens front cover with the circuit board in FIG. 3.

FIG. 5 is a whole structure diagram of a single-shaft lens device for a UAV (unmanned aerial vehicle) according to the first embodiment of the present invention.

FIG. 6 is a whole structure diagram of an optical flow lens installation structure for a UAV according to a second embodiment of the present invention.

FIG. 7 is a local enlarged schematic diagram of X-portion of the optical flow lens installation structure for the UAV according to the second embodiment of the present invention.

FIG. 8 is a partially sectional schematic diagram of the optical flow lens installation structure for the UAV.

In the drawings, 11: lens front cover; 12; lens rear cover; 13: lens module; 14: first circuit board; 15: first FPC line; 21: actuator; 22: drive wheel; 23: driven wheel; 110: drawtube tank; 111: hook; 112: first positioning block; 113: first screw connection portion; 114: second screw connection portion; 115: transparent protective lens; 131: lug; 3: lens shaft; 4: lens support; 5: second screw component; 6: first screw component; 1: optical flow lens unit; 2: optical flow support; 210: installation concave part; 220: flexible flip; 230: flexible fixing block; 24: reducing hole; 30: second circuit board; 31: second positioning block; 40: aircraft housing; 41: bottom cover; 50: optical flow lens.

### DETAILED DESCRIPTION OF THE PREFERRED EMBODIMENT

In order to make the above objects, features and advantages of the present invention clearer and easier to be understood, the specific embodiments of the present invention are described in detail below with reference to the accompanying drawings.

In the following description, numerous specific details are set forth to provide a thorough understanding of the present invention. However, the present invention can be implemented in many different ways from those described herein. One skilled in the art can make similar promotion without violating the present invention. Therefore, the present invention is not limited to the specific embodiments disclosed below.

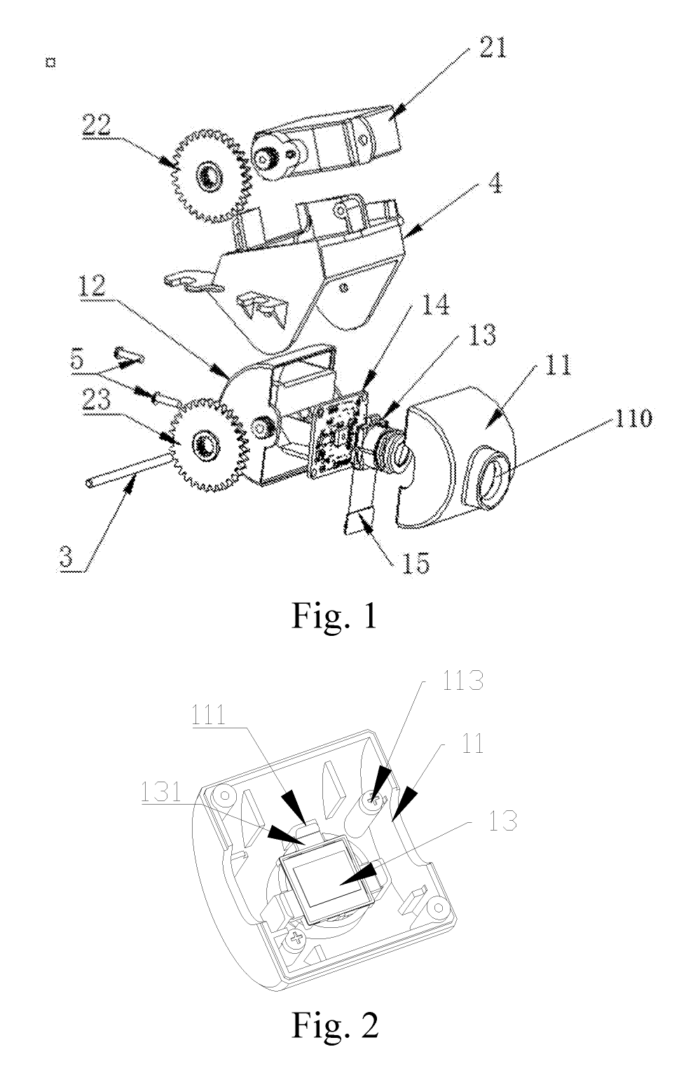

Referring to FIGS. 1 to 5, according to a first embodiment of the present invention, a single-shaft lens device for a UAV (unmanned aerial vehicle) is illustrated, which comprises a drive apparatus and a lens apparatus, and is adapted for being installed into an aircraft housing of the UAV, wherein a control circuit in the aircraft housing is adapted for controlling the drive apparatus to drive, and the lens apparatus is driven through the drive apparatus to uniaxially rotate around a lens shaft 3.

The lens apparatus comprises a lens front cover 11, a lens rear cover 12, a lens module 13 and a first circuit board 14, which is not limited. The first circuit board 14 is able to be a circuit board installed with a sensor such as a gyroscope, which is not limited and also able to be a circuit board for preprocessing and transmitting data or a multi-functional integrated circuit board. The lens shaft 3 is sleeved to the lens front cover 11 or the lens rear cover 12. In FIG. 1, the lens shaft 3 is sleeved to the lens rear cover 12.

The lens module 13 is buckled with the lens front cover 11, the first circuit board 14 tightly presses the lens module 13 and is connected with the lens front cover 11, the lens rear cover 12 is connected with the lens front cover 11 after the lens rear cover 12 covers the lens front cover 11, the assembled lens apparatus wholly rotates around the lens shaft 3. The lens rear cover 12 covered with the lens front cover 11 is cylindrical as a whole, the lens shaft 3 is located at an axis of the cylinder, the lens apparatus rotates at a circumferential direction of the cylinder; of course, a rotational angle range is able to be determined as required.

To better collect images, a lens shooting portion generally extends a distance relatively to other portions of the lens apparatus, and the lens apparatus rotates around the single shaft, which is able to save a larger exercise space and reduce a volume and weight of the aircraft housing of the UAV. The lens module 13 is buckled with the lens front cover 11 for eliminating the installation of screws, which is simple in assembling and disassembling manners and is able to reduce a whole weight and decrease the signal interference. Moreover, through tightly pressing the lens module 13 to the lens front cover 11 via the first circuit board 14, so as to further fix the lens module 13 for obtaining a more stable installation manner.

Referring to FIG. 2, a drawtube tank 110 is provided on the lens front cover 11, a front end of the lens module 13 extends into the drawtube tank 110 for positioning, a specific shape and structure of the drawtube tank 110 are not limited and are able to be determined according to a shape of the lens module 13; the drawtube tank 110 is also able to be formed through several baffles spacedly arranged from each other for a circle. A hook 111 is located at a tank edge of the drawtube tank 110, a lug 131 is located at a rear end of the lens module 13, the lug 131 is buckled with the hook 111 when the lens module 13 extends in position, so that the lens module 13 is fixed to the lens front cover 11. FIG. 2 shows that three hooks 111 are respectively buckled with three lugs 131 for more stably fixing the lens module 13, which is not easy to shake.

Through the drawtube tank 110, the lens module 13 is rapidly positioned, and the lens shooting portion extends outside a distance relatively to other portions of the lens apparatus; the buckling between the hooks 111 and the lugs 131 is able to complete the buckling during the process of downwardly pressing the lens module 13 in the drawtube tank 110, so that the buckling manner is more stable and convenient.

A top surface of each hook 111 faces towards an inner side of the drawtube tank 110 and is downwardly inclined, as shown in FIG. 2, all inclined surfaces of three hooks 111 face towards the drawtube tank 110 and are downwardly inclined, so that while being downwardly pressed along the inclined surface, the lens module 13 is easier to be buckled with the hooks 111.

The first circuit board 14 is connected with a first screw connection portion 113 of the lens front cover 11 through a first screw component 6 in a screw connection manner, such that the lens module 13 is tightly pressed and is fixedly connected with the lens front cover 11. The first screw connection portion 113 is located inside the lens front cover 11, and a height of the first screw connection portion 113 is almost as same as a height of an end portion of the lens module 13. The first circuit board 14 contacts not only the first screw connection portion 113 but the lens module 13. After screwing the first screw component 6 onto the first screw connection portion 113, the lens module 13 is tightly pressed in the drawtube tank 110.

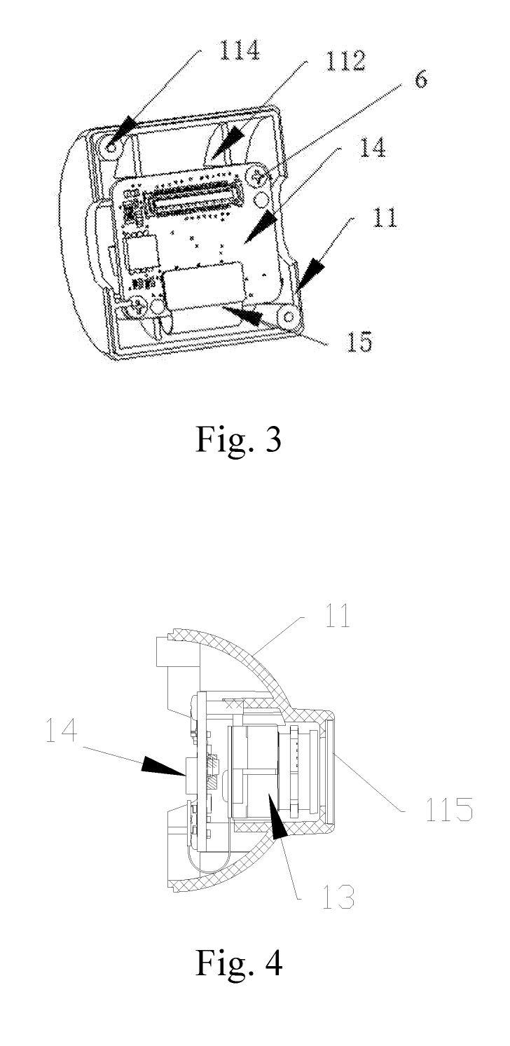

Preferably, at least two first positioning blocks 112 are located at an inner side of the lens front cover 11, the first circuit board 14 is positioned between the first positioning blocks 112. As shown in FIGS. 2 and 3, multiple first positioning blocks 112 are located at the inner side of the lens front cover 11 for positioning the first circuit board 14 in all directions up and down, so that no shift and loose occurs after fixing the first circuit board 14.

After the lens rear cover 12 is covered with the lens front cover 11, a second screw connection portion 114 of the lens front cover 11 is connected therewith in a screw connection manner through a second screw component 5, so as to fix the lens rear cover 12 with the lens front cover 11. The screw components are able to be screws which are not limited.

Preferably, as shown in FIGS. 3 and 4, the lens module 13 is connected with the first circuit board through a first FPC (flexible printed circuit) line 15 for data transmission between the lens module 13 and the first circuit board 14. The first circuit board 14 is connected with an external circuit through a second FPC line (not shown in the drawings), the second FPC line extends to an exterior through an opening of the lens rear cover 12 for data transmission between the first circuit board 14 and the external circuit, for indirect transmission between the lens module 13 and the external circuit. The FPC lines are able to avoid complicated circuits of the lens apparatus.

Preferably, referring to FIG. 4, a transparent protective lens 115 is located at the lens front cover 11 corresponding to the lens module 13 for protecting the lens module 13 to convenient for being cleaned. The lens module 13 shoots the external environment through the transparent protective lens 115.

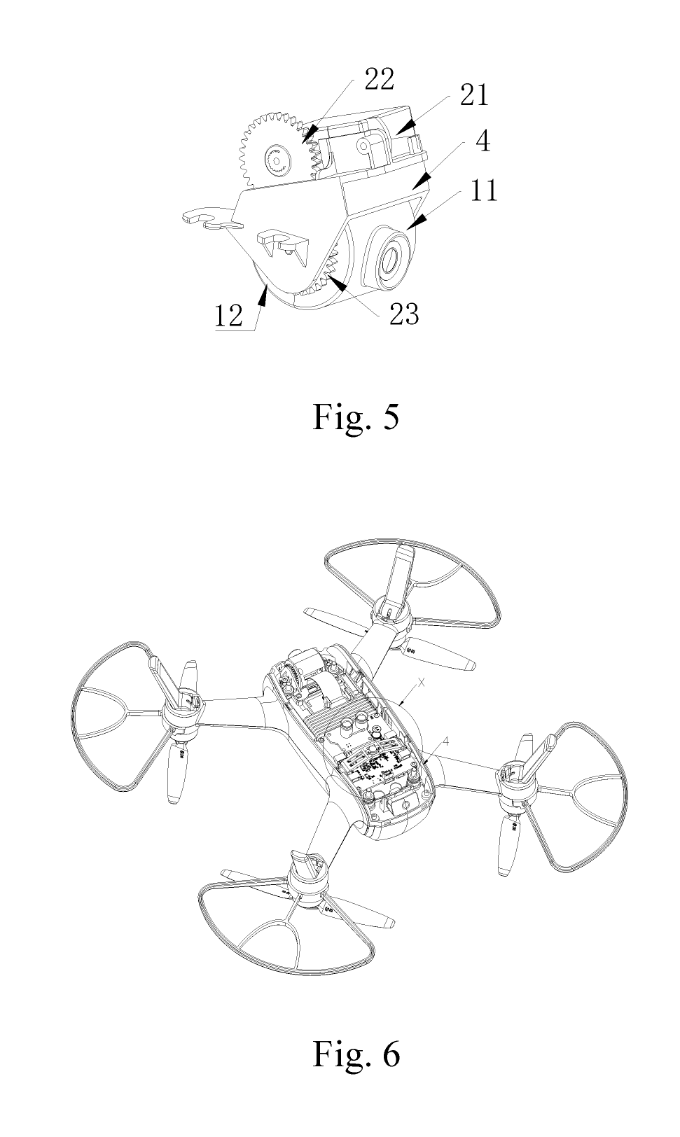

Preferably, as shown in FIGS. 1 and 5, the drive apparatus comprises an actuator 21 and a gear. The gear comprises a drive wheel 22 and a driven wheel 23. The drive wheel 22 is connected with the actuator 21, the driven wheel 23 is connected with the lens apparatus and is engaged with the drive wheel 22. The actuator 21 drives the drive wheel 22 to rotate, so as to drive the driven wheel to rotate, for driving the lens apparatus to rotate around the lens shaft 3 to achieve the single-axle rotation.

Preferably, as shown in FIGS. 1 and 5, the single-axle lens device for the UAV further comprises a lens support 4. Both the drive apparatus and the lens apparatus are installed on the lens support 4, wherein the actuator 21 is fixedly connected with the lens support 4, the lens shaft 3 is fixedly connected with the lens support 4, two ends of the lens shaft 3 are fixed to the lens support 4, both the driven wheel 23 and the lens apparatus are able to rotate relatively to the lens support 4.

Referring to FIGS. 6 to 8, an optical flow lens installation structure for a UAV according to a second embodiment of the present invention is illustrated, which comprises an aircraft housing 40 and a second circuit board 30 located inside the aircraft housing 40, wherein the second circuit board 30 is able to be the main circuit board of the UAV which is not limited, and is at least a circuit board adapted for data exchanging with an optical flow lens unit 1.

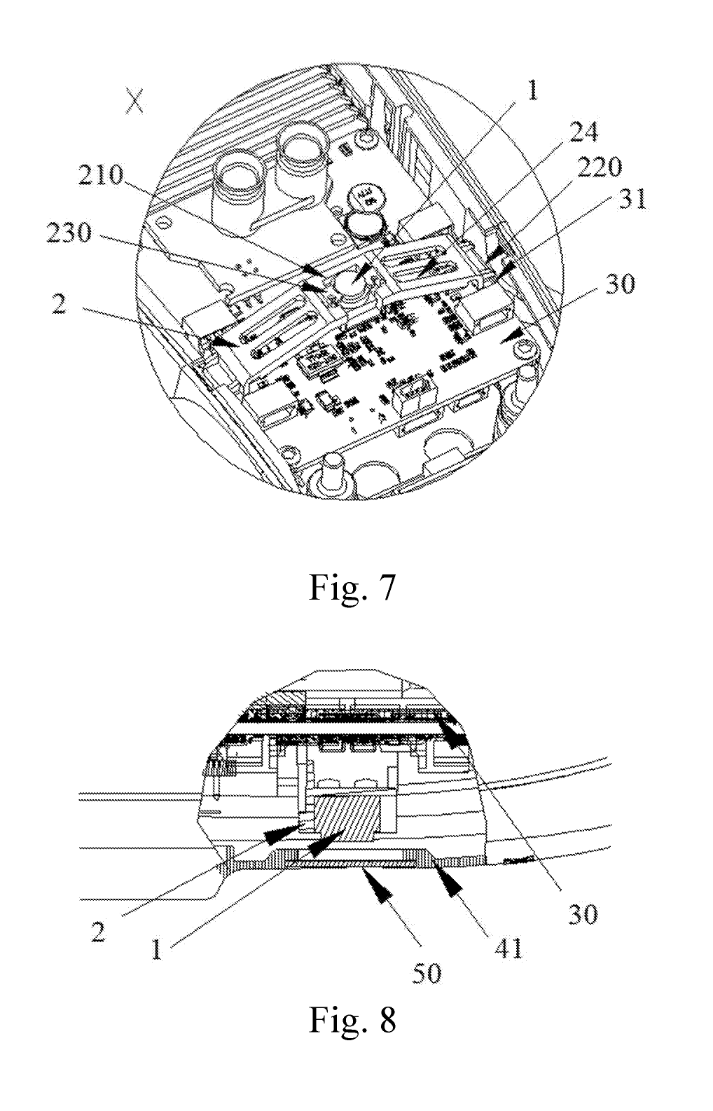

The optical flow lens installation structure for the UAV comprises an optical flow support 2 and an optical flow lens unit 1. The optical flow support 2 is arched which means that the optical flow support 2 comprises an upwardly arched portion 200 and two arms 201 downwardly extended from two ends of the upwardly arched portion, respectively. As shown in FIG. 7, the arched portion 200 of the optical flow support 2 is an upwardly arched mesa, the two arms 201 of the optical flow support 2 are downwardly bent or folded (here, “upwardly” and “downwardly” only for the direction shown in FIG. 7 which are not limited). The arched portion 200 of the optical flow support 2 comprises an installation concave part 210 for installing the optical flow lens unit 1. A shape and a size of the installation concave part 210 are able to be determined according to a shape and a size of the optical flow lens unit 1, respectively. Two ends of the optical flow support 2 embrace the second circuit board 30, so as to carry the optical flow lens unit 1 to fix with the second circuit board 30. The optical flow support 2 is fixed to a bottom surface of the second circuit board 30. The arched portion 200 of the optical flow support 2 faces downwardly to allow the optical flow lens unit 1 to face towards a bottom of the aircraft housing 40. FIG. 7 shows the aircraft fuselage of the UAV is turned over, so an arched direction of the arched portion faces downwardly.

The optical flow lens unit 1 is indirectly connected with the second circuit board 30, but is connected with the second circuit board 30 through the optical flow support 2. After being installed to the arched portion 200 of the optical flow support 2, the optical flow lens unit 1 faces towards the bottom of the aircraft housing 40 and is arched downwardly, causing a distance between the optical flow lens unit 1 and the bottom of the aircraft housing 40 is closer, so that the images collected by the optical flow lens unit 1 are able to more truly reflect the external environment, thus the visual positioning is more accurate and errors are reduced. Moreover, compared with the optical flow lens unit 1 in direct installation with the second circuit board 30, the assembly method, that the optical flow lens unit 1 is fixed to the optical flow support 2, and then the optical flow support 2 is fixed to the second circuit board 30, is more simple and easy to disassemble.

Preferably, the optical flow support 2 further comprises flexible flips 220 which are respectively located at the two ends thereof and are flipped up away from the arched portion 200. When the flexible flips 220 flexibly flip up, the optical flow support 2 is opened, the flexible flips 220 flip up to a top surface of the second circuit board 30 (which is opposite to the arched portion), so that the flexible flips 220 respectively are in matched connection with two sides of the second circuit board 30; after being reset and closed, the flexible flips 220 embrace the second circuit board 30, so that the whole optical flow support 2 is fixed to the second circuit board 30.

Through the flexible flip and reset of the flexible flips 220, the optical flow support 2 is fixedly connected with the second circuit board 30, so that other connecting parts are able to be removed, which facilitates disassembling and assembling. In addition, the above connection manner does not damage to the second circuit board 30.

The flexible flips 220 and the arms 201 of the optical flow support 2 are integrally formed or separated from each other. The flexible flips 220 are able to be made of flexible materials or the whole optical flow support 2 is made of flexible materials. The flexible materials are able to be plastic materials with a certain flexibility.

Preferably, referring to FIG. 7, second positioning blocks 31 are respectively located at two sides of the second circuit board 30 for positioning the optical flow support 2. There are two second positioning blocks 31 located at each side of the second circuit board 30, a spacing between the two second positioning blocks 31 located at each side of the second circuit board 30 is just adapted for accommodating one flexible flip 220 of the optical flow support 2 to prevent the optical flow support 2 from moving left and right, and to rapidly install the optical flow lens unit 1 to a desired position.

Preferably, one side of the installation concave part 210 of the optical flow support 2 is opened for allowing the optical flow lens unit 1 to slide into the installation concave part 210, that is, a side wall of the installation concave part 210 has a notch, the optical flow lens unit 1 is able to slide into the installation concave part 210 through the notch. After sliding into the notch, the optical flow lens unit 1 is able to be fixed in any manner.

Preferably, two flexible fixing blocks 230 are located on the optical flow support 2. The two flexible fixing blocks 230 are respectively fixed at two sides of the installation concave part 210, and specific positions of the two flexible fixing blocks 230 may be determined in accordance with the cooperation with the optical flow lens unit 1. When the optical flow lens unit 1 slides, the two flexible fixing blocks 230 are pushed by the optical flow lens unit 1 to flexibly act along a sliding direction of the optical flow lens unit 1, so that the optical flow lens unit 1 slides into the installation concave part 210; after the optical flow lens unit 1 slides into the installation concave part 210 in position, the two flexible fixing blocks 230 are flexibly reset to embrace the optical flow lens unit 1 for fixing. Through the flexible action and reset, the optical flow lens unit 1 is fixed, so that extra connection members are removed to reduce the weight. In addition, the optical flow lens unit 1 is simple in assembly and disassembly, and is able to slide into or out of the installation concave part 210 under the external force.

More preferably, each of the flexible fixing blocks 230 is concaved and has a U-shaped structure, a concave direction of the concave portion of every flexible fixing block 230 is opposite to the sliding direction of the optical flow lens unit 1, so when the optical flow lens unit 1 slides into the installation concave part 210, the concave portion of every flexible fixing block 230 is opened under the push action, the flexible action and the reset of every flexible fixing block 230 are more convenient. A transition cutting angle is provided at a position where every flexible fixing block 230 is pushed by the sliding optical flow lens unit 1. When every flexible fixing block 230 is pushed, the optical flow lens unit 1 applies a force to the transition cutting angle, so that the force applied to the flexible fixing block 230 is more stable, and the flexible fixing block 230 is more smoothly opened. Instead of the smooth transition, the transition cutting angle is able to prevent the optical flow lens unit 1 from easily sliding outside the installation concave part 210. A position where every flexible fixing block 230 embraces the optical flow lens unit 1 is an arc which matches with the optical flow lens unit 1, so that a friction between the flexible fixing block 230 and the optical flow lens unit 1 is lager to more stably fix with each other. Accordingly, the optical flow lens unit 1 does not easily slide outside the installation concave part 210 or move up and down.

Preferably, the optical flow support 2 has at least one reducing hole 24. As shown in FIG. 7, there are four reducing holes 24 on the optical flow support 2 which are symmetrically distributed at two sides of the arched portion 200 for reducing the weight of the optical flow support 2, so as to further reduce the weight of the whole device.

Preferably, a buffer foam (not shown in the drawings) is located between an installation position of the optical flow lens unit 1 and the second circuit board 30 for buffering the optical flow lens unit 1; the optical flow lens unit 1 is fixed in the installation concave part 210 of the optical flow support 2, so that the buffer foam is located between an installation position of the installation concave part 210 and the second circuit board 30, and is able to be in contact with the optical flow support 2 in the tight press or non-tight press manner. A wall of the installation concave part 210 has a threading hole for allowing lines to pass through. The buffer foam is able to fix connection wires for connecting the optical flow lens unit 1 and the second circuit board 30 on the second circuit board 3, so as to fix the connection wires through the buffer foam.

Preferably, referring to FIG. 8, an optical flow lens 50, adapted for light transmission and protection, is located at a position where is corresponding to the optical flow lens unit 1 at the bottom of the aircraft housing 40. The bottom of the aircraft housing 40 is a bottom cover 41 which is able to be opened or closed. The optical flow lens 50 is located on the bottom cover 41, which facilitates cleaning the lens and lens apparatus.

While the present invention has been described in terms of the above preferred embodiments, the above preferred embodiments are not intended to limit the scope of the present invention. One skilled in the art can make possible variations and modifications without departing from the spirit and scope of the present invention. Therefore, the protection scope of the present invention should be subject to the scope defined by the claims of the present invention.

What is claimed is:

1. A single-shaft lens device for a UAV (unmanned aerial vehicle), which comprises a drive apparatus and a lens apparatus, wherein:
the lens apparatus is driven through the drive apparatus to uniaxially rotate around a lens shaft; the lens apparatus comprises a lens front cover, a lens rear cover, a lens module and a first circuit board; the lens shaft is sleeved to the lens front cover or the lens rear cover; the lens module is buckled with the lens front cover, the first circuit board tightly presses the lens module and is connected with the lens front cover, the lens rear cover is connected with the lens front cover after the lens rear cover is covered with the lens front cover.

2. The single-shaft lens device for the UAV, as recited in claim 1, wherein a drawtube tank is provided on the lens front cover, a front end of the lens module extends into the drawtube tank for positioning, a hook is located at a tank edge of the drawtube tank, a lug is located at a rear end of the lens module, the lug is buckled with the hook when the lens module extends in position, so that the lens module is fixed to the lens front cover.

3. The single-shaft lens device for the UAV, as recited in claim 2, wherein a top surface of each hook faces towards an inner side of the drawtube tank and is downwardly inclined.

4. The single-shaft lens device for the UAV, as recited in claim 2, wherein the first circuit board is connected with a first screw connection portion of the lens front cover through a first screw component in a screw connection manner, such that the lens module is tightly pressed and is fixedly connected with the lens front cover.

5. The single-shaft lens device for the UAV, as recited in claim 4, wherein at least two first positioning blocks are located at an inner side of the lens front cover, the first circuit board is positioned between the first positioning blocks.

6. The single-shaft lens device for the UAV, as recited in claim 1, wherein the lens rear cover is connected with a second screw connection portion of the lens front cover in a screw connection manner through a second screw component.

7. The single-shaft lens device for the UAV, as recited in claim 1, wherein the lens module is connected with the first circuit board through a first FPC (flexible printed circuit) line.

8. The single-shaft lens device for the UAV, as recited in claim 1, wherein a transparent protective lens is located at the lens front cover corresponding to the lens module.

9. The single-shaft lens device for the UAV, as recited in claim 1, wherein the drive apparatus comprises an actuator and a gear, the gear comprises a drive wheel and a driven wheel, the drive wheel is connected with the actuator to rotate under a drive of the actuator, the driven wheel is connected with the lens apparatus and is engaged with the drive wheel, the drive wheel drives the driven wheel to rotate so as to drive the lens apparatus to rotate around the lens shaft to achieve a single-axle rotation.

10. The single-shaft lens device for the UAV, as recited in claim 1, further comprising a lens support for installing the drive apparatus and the lens apparatus, two ends of the lens shaft are fixed to the lens support.

11. An optical flow lens installation structure for a UAV (unmanned aerial vehicle), wherein:
the UAV comprises an aircraft housing and a second circuit board located inside the aircraft housing;
the optical flow lens installation structure comprises an optical flow support and an optical flow lens unit;
the optical flow support is arched and comprises an arched portion and two arms downwardly extended from two ends of the arched portion, respectively;
the arched portion of the optical flow support comprises an installation concave part for installing the optical flow lens unit;
two ends of the optical flow support embrace the second circuit board for fixing and allows the optical flow lens unit to face towards a bottom of the aircraft housing.

12. The optical flow lens installation structure for the UAV, as recited in claim 11, wherein the optical flow support further comprises flexible flips which are respectively located at the two ends thereof and are flipped up away from the arched portion, the flexible flips respectively are in matched connection with two sides of the second circuit board, the flexible flips embrace the second circuit board after being reset and closed.

13. The optical flow lens installation structure for the UAV, as recited in claim 12, wherein second positioning blocks are respectively located at two sides of the second circuit board for positioning the optical flow support.

14. The optical flow lens installation structure for the UAV, as recited in claim 11, wherein one side of the installation concave part of the optical flow support is opened for allowing the optical flow lens unit to slide into the installation concave part.

15. The optical flow lens installation structure for the UAV, as recited in claim 14, wherein two flexible fixing blocks are located on the optical flow support and are respectively fixed at two sides of the installation concave part; when the optical flow lens unit slides, the flexible fixing blocks flexibly act along a sliding direction of the optical flow lens unit; after the optical flow lens unit slides into the installation concave part in position, the two flexible fixing blocks are flexibly reset to embrace the optical flow lens unit.

16. The optical flow lens installation structure for the UAV, as recited in claim 15, wherein each of the flexible fixing blocks is concaved, a concave direction of a concave portion of every flexible fixing block is opposite to the sliding direction of the optical flow lens unit, a transition cutting angle is provided at a position where every flexible fixing block is pushed by the sliding optical flow lens unit, a position where every flexible fixing block embraces the optical flow lens unit is an arc which matches with the optical flow lens unit.

17. The optical flow lens installation structure for the UAV, as recited in claim 11, wherein the optical flow support has at least one reducing hole.

18. The optical flow lens installation structure for the UAV, as recited in claim 11, wherein an optical flow lens, adapted for light transmission and protection, is located at a position where is corresponding to the optical flow lens unit at the bottom of the aircraft housing.
